(19) United States
(12) Patent Application Publication
(10) Pub. No.: US 2018/0253146 A1
(43) Pub. Date: Sep. 6, 2018

(54) NAIL-MOUNTED TACTILE DISPLAYING DEVICE

(71) Applicants: National Taiwan University, Taipei (TW); MEDIATEK INC., Hsin-Chu City (TW)

(72) Inventors: Bing-Yu CHEN, Taipei (TW); Meng-Ju HSIEH, Taipei (TW); Rong-Hao LIANG, Taipei (TW)

(21) Appl. No.: 15/695,917

(22) Filed: Sep. 5, 2017

(30) Foreign Application Priority Data
Mar. 3, 2017 (TW) 106106980

(51) Int. Cl. G06F 3/01

(52) U.S. Cl. CPC G06F 3/014; G06F 1/163

(57) ABSTRACT

The present disclosure provides a nail-mounted tactile displaying device, including: a body; a plurality of vibration units provided at different positions of the body and actuated upon receiving a signal. The nail-mounted tactile displaying device provides a user with a new operating experience via the actuations of the plurality of vibration units so that the user can receive information through tactile feedback.

### BACKGROUND

### 1. Technical Field

The present disclosure relates to tactile displaying devices, and, more particularly, to a tactile displaying device that can be mounted on a finger nail.

### 2. Description of Related Art

Due to the rapid development of modern science and technology, personalized electronic products are becoming more prevalent. Such electronic products are generally controlled through touches of the fingers of users. For example, a smart phone is equipped with a touch display on its surface that allows a user to perform manipulations on the touch display when the user is looking at various information displayed on the phone.

The above-described electronic device may be referred to as a visual display, and such a display has now become available to be worn on a user's finger nail to provide the user with an image on a part of the display that is being blocked by the finger while the user is manipulating the touch display. However, such a visual display only plays a role when the user's eyes are looking at it. In the event that the user is unable to focus on the visual display, such as during a conference, driving or exercise, the user cannot receive information effectively.

Therefore, there is a need for a displaying device that allows a user to effectively receive information while the user's eyes are focusing somewhere else.

### SUMMARY

One objective according to the present disclosure is to provide a nail-mounted tactile displaying device, which may include: a body; and a plurality of vibration units provided on different locations of the body and actuated upon receiving a signal.

The nail-mounted tactile displaying device according to the present disclosure allows a user to receive vibration signals containing spatial information via the user's skin or finger nail(s) through actuations of the plurality of vibration units, so that the user is able to receive information in a tactile manner through his/her finger nail(s), and the device effectively achieves high resolution and high recognition rate, providing the user with a new operating experience.

### BRIEF DESCRIPTION OF THE DRAWINGS

FIG. 1 is a schematic diagram illustrating an embodiment of a nail-mounted tactile displaying device in accordance with the present disclosure;

FIG. 2 is a functional block diagram of the nail-mounted tactile displaying device in accordance with the present disclosure;

FIG. 3A is a schematic diagram illustrating another embodiment of a nail-mounted tactile displaying device in accordance with the present disclosure;

FIG. 3B is a schematic diagram illustrating yet another embodiment of a nail-mounted tactile displaying device in accordance with the present disclosure; and

FIG. 4 is a schematic diagram illustrating the order of strokes in EdgeWrite stroke recognition text entry method formed from the vibration order of vibration units of the nail-mounted tactile displaying device in accordance with the present disclosure.

### DETAILED DESCRIPTION OF THE EMBODIMENTS

The present disclosure is described by the following specific embodiments. Those with ordinary skills in the arts can readily understand other advantages and functions according to the present disclosure after reading the disclosure of this specification. The present disclosure may also be practiced or applied with other different implementations. Based on different contexts and applications, the various details in this specification can be modified and changed without departing from the spirit of the present disclosure.

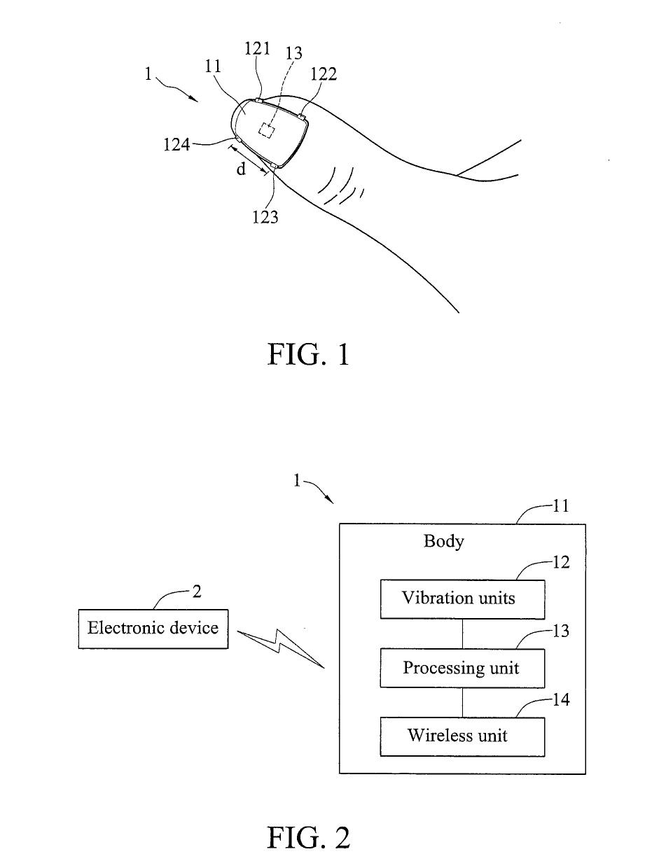

Referring to FIG. 1, a nail-mounted tactile displaying device 1 according to the present disclosure includes a body 11 and a plurality of vibration units 121, 122, 123 and 124. The nail-mounted tactile displaying device 1 can be mounted on the finger nail of a user's finger, such as the nail of the thumb, the index finger, the middle finger, etc. The present disclosure neither limits the nail-mounted tactile displaying device 1 to be mounted on any specific finger nail, not limits a number of the nail-mounted tactile displaying device 1 that can be simultaneously worn by the user.

The body 11 of the nail-mounted tactile displaying device 1 according to the present disclosure has an appearance similar to a nail. The body 11 can be, for example, a synthetic finger nail, or may assume other shape that can be mounted on a finger nail. Thus, a user can easily and quickly mount the nail-mounted tactile displaying device according to the present disclosure on his/her finger nail(s), and when the nail-mounted tactile displaying device 1 according to the present disclosure is worn by the user, there will not be any sense of contradictions when in use.

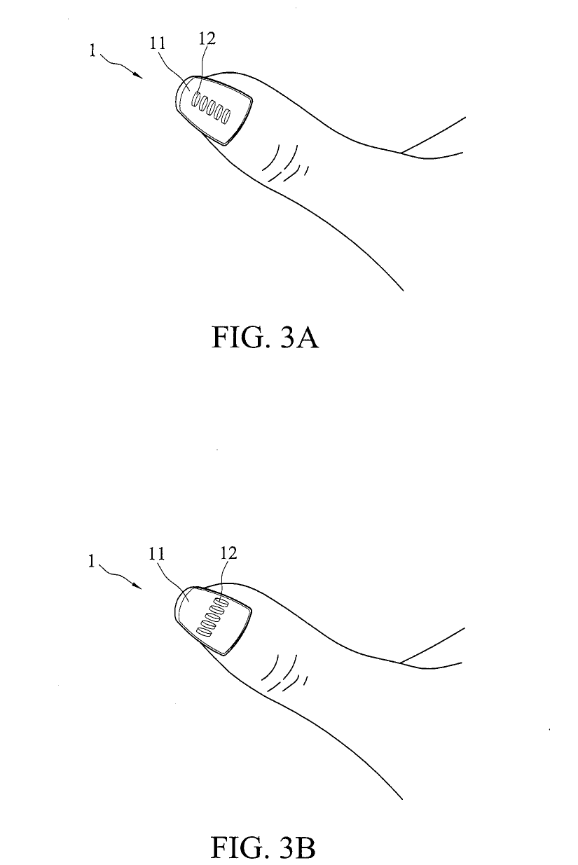

The plurality of vibration units 121, 122, 123 and 124 are provided on different locations of the body 11 and actuated upon receiving respective signals. The user may sense the actuations of the vibration units 121, 122, 123 and 124 via his/her skin or finger nail in a tactile way. In an embodiment, as shown in FIG. 1, the vibration units 121, 122, 123 and 124 are in a number of four, and provided at four corners of the body 11, respectively, so the plurality of vibration units 121, 122, 123 and 124 can be arranged in a 2×2 matrix, but the present disclosure is not limited as such. In an embodiment, as shown in FIGS. 3A and 3B, the vibration units 12 are in a number of five, and arranged in a 1×5 matrix (as shown by the horizontal arrangement of vibration units 12 in FIG. 3A) or a 5×1 matrix (as shown by the vertical arrangement of vibration units 12 in FIG. 3B), or a 5×5 matrix.

The vibration units 12, 121, 122, 123 and 124 can be provided on the body 11 by an adhesive, but the present disclosure is not limited as such.

In an embodiment, the vibration units 12, 121, 122, 123 and 124 can be implemented as one of an eccentric rotating mass actuator, a linear resonant actuator and a miniature multilayer piezo actuator, or a combination thereof, and the present disclosure is not limited to these. In a preferred embodiment according to the present disclosure, the miniature multilayer piezo actuator is used as the vibration unit. Since the dimension of the miniature multilayer piezo actuator (e.g., PI PL022.30 PICMA Chip Actuator manufactured by PICERAMIC) is 2×2×2 mm³ and a response time is less than 2 ms, the product can be easily miniaturized with increased usability.

The nail-mounted tactile displaying device 1 according to the present disclosure further includes a processing unit 13. The processing unit 13 is provided in the body 11 and electrically connected to the plurality of vibration units 121, 122, 123 and 124 for sending signals to the plurality of vibration units 121, 122, 123 and 124 based on an instruction in order to control the vibration order (the order in which the vibration units are turned on and off), the vibration intensity or the vibration frequency of the plurality of vibration units 121, 122, 123 and 124.

Referring to FIGS. 1 and 2, the block representing the vibration units 12 in FIG. 2 is merely schematic for illustrating the connection relationship of the vibration units 12 with other elements, and does not imply that there is only one vibration unit 12. In an embodiment, the vibration units 12 are electrically connected with the processing unit 13, and the processing unit 13 receives instructions sent by an external electronic device 2 via a wireless unit 14. In an embodiment, the wireless unit 14 can be a wireless network module or a Bluetooth module (hardware circuit). In another embodiment, the processing unit 13 receives instructions through a wired network. The present disclosure does not limit how the processing unit 13 receives an instruction. The abovementioned instruction is an instruction of the order in which the vibration units are turned on and off corresponding to a message that the external electronic device 2 wishes to convey in terms of spatial locations of the vibration units 12.

The processing unit 13 refers to a micro PCB with a processor or other miniature electronic device with a processor.

In an embodiment, the electronic device 2 can be a smart phone, or smart watch, a tablet PC, a desktop computer, a wearable electronic device (e.g., Google Glass), etc., and the present disclosure is not limited as such. For example, the electronic device 2 is a smart watch, and the nail-mounted tactile displaying device 1 according to the present disclosure can be paired with the smart watch via Bluetooth, so that the smart watch can transmit instructions to the processing unit 13 in the nail-mounted tactile displaying device 1.

In an embodiment, any two of the plurality of vibration units are spaced at a distance ranging from 4 to 16 mm. As shown in FIG. 1, the distance d between the vibration units 123 and 124 ranges from 4 to 16 mm. For example, the distance d can be, but not limited to, 4, 8, 12 or 16 mm, and is preferably 12 mm or more.

In another embodiment, the processing unit 13 actuates at least one of the plurality of vibration units 12, 121, 122, 123 and 124 at the same time in order for the user to identify the actuating one of the vibration units 12, 121, 122, 123 and 124. The processing unit 13 can also actuate at least two of the plurality of vibration units 12, 121, 122, 123 and 124 at the same time, and the present disclosure is not limited as such.

The following experiments were made by the inventors to obtain statistical data on the number of actuating vibration units that users are able to correctly identify. Users were separated into two groups, each of which has twelve people. The first group wore the nail-mounted tactile displaying device 1 shown in FIG. 3A (where the vibration units 12 are arranged in a 1×5 matrix), whereas the second group wore the nail-mounted tactile displaying device 1 shown in FIG. 3B (where the vibration units 12 are arranged in a 5×1 matrix). Next, the processing unit 13 transmits two signals sequentially for actuating the vibration units. The users were then asked with the question that whether the vibration units controlled by these two signals are the same or not. The experimental parameters are as follow: the vibration duration of the vibration units 12 was set to 400 ms; the pause time between actuations of two vibration units was set to 200 ms; each signal was repeated three times; and there were a total of 10 rounds with 25 different signals in each round.

After the statistics on actual identification are gathered by the users, it is found that if any two of the vibration units was kept at 4 mm, the user identification accuracy reached about 41% to 45%; if any two of the vibration units was kept at 8 mm, the user identification accuracy reached about 65.2% to 65.6%; and if any two of the vibration units was kept at 12 or 16 mm, the user identification accuracy reached about 71.7% to 80.8%. Thus, the greater the distance between any two of the vibration units is, the higher the user identification accuracy becomes. However, a greater distance means that the overall size of the nail-mounted tactile displaying device according to the present disclosure is larger. Therefore, it is preferable to locate the vibration units as far as apart as the size would allow to obtain the highest identification accuracy possible (i.e., the most preferable distance is 12 mm or more).

While the nail-mounted tactile displaying device 1 with vibration units arranged in a 2×2 matrix as shown in FIG. 1 was worn by the user and also underwent a similar experiment as that described above, it is found that user recognition accuracy reaches at least 87.8% above.

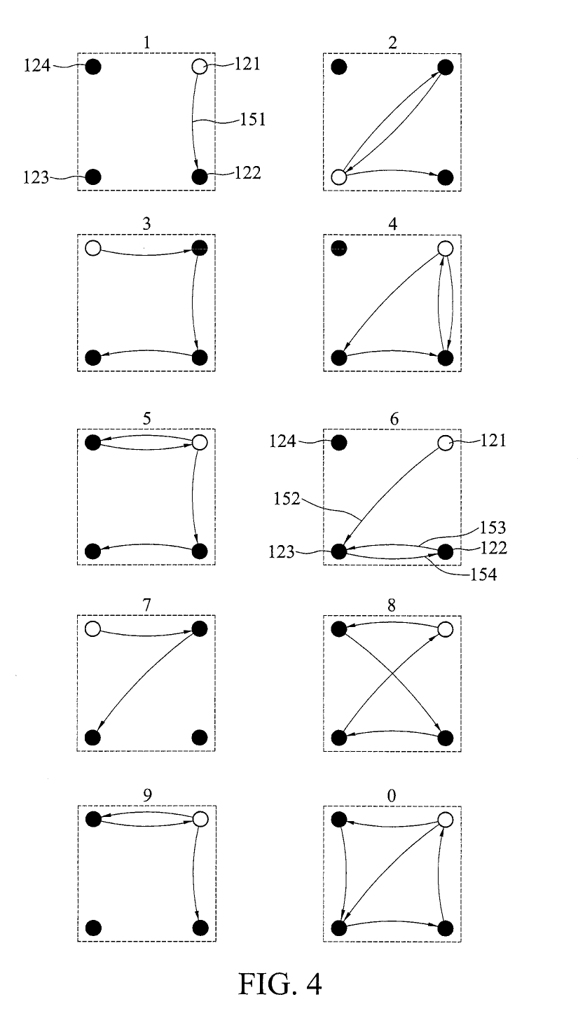

Referring to FIG. 4, the order in which the plurality of vibration units 121, 122, 123 and 124 of the nail-mounted tactile displaying device 1 according to the present disclosure vibrate may form the order of strokes in EdgeWrite stroke recognition text entry method. As shown in FIG. 4, the vibration unit 121 is first caused to vibrate, and then the vibration unit 122 is caused to vibrate, so that a user feels a vibration order 151 from the vibration unit 121 to vibration unit 122. This vibration order 151 may correspond to the number “1”. As another example, the vibration unit 121, the vibration unit 123, the vibration unit 122, and again vibration unit 123 are caused to vibrate in the described order, so that the user feels vibration orders 152, 153, 154, which may correspond to the number “6”. In other words, a user can convey image information (e.g., the number “6”) through the vibration order(s) of the vibration units at different locations. The vibration units shown as white dots in FIG. 4 (e.g., the vibration unit 121 for the number “1”) indicates the vibration units that start the particular vibration order. In cooperation of arrow information of vibration orders, one with ordinary skill in the art may easily appreciate other numbers represented by the vibration orders of the vibration units through illustrations of FIG. 4, and the present disclosure is not limited as such.

The nail-mounted tactile displaying device 1 with vibration units arranged in a 2×2 matrix as shown in FIG. 1 also underwent a similar experiment as that described above, and it is found that user recognition accuracy reaches 100% when recognizing number “1” or “7” in EdgeWrite stroke recognition text entry method, with the accuracy reaching at least 83% above in the events of recognizing other numbers.

In an embodiment, a RFID reading device can be further provided in the body 11 of the nail-mounted tactile displaying device 1 according to the present disclosure. For example, when a user is holding a card with a RFID tag, the information contained in the card is read via the RFID reading device (e.g., the balance), and this information within the card is then represented by the vibration units 12 of the nail-mounted tactile displaying device 1 according to the present disclosure. Furthermore, a NFC reading device can also be further provided in the body 11 of the nail-mounted tactile displaying device 1 according to the present disclosure, its application is similar to the RFID reading device above, but the present disclosure is not limited as such.

In summary, the nail-mounted tactile displaying device according to the present disclosure allows a user to receive vibration signals (e.g., vibration order, vibration intensity or vibration frequency) containing spatial information via the user's skin or finger nail(s) through actuations of the plurality of vibration units, so that the user is able to receive information in a tactile manner when the user cannot look at the device with his/her eyes (e.g. in a meeting, during driving or exercise), and the device has the technical effects of high resolution and high recognition rate. Moreover, the nail-mounted tactile displaying device according to the present disclosure assumes the appearance of a finger nail or some other shape, which allows the user to maintain the natural tactile impression of the fingertip, and at the same time does not affect the daily activity of the finger, providing the user with a new operating experience.

The above embodiments are only used to illustrate the principles, advantages and efficacy according to the present disclosure, and should not be construed as to limit the present disclosure in any way. The above embodiments can be modified by those with ordinary skill in the art without departing from the scope according to the present disclosure as defined in the following appended claims.

What is claimed is:

1. A nail-mounted tactile displaying device, comprising:
a body; and
a plurality of vibration units provided on different locations of the body and actuated upon receiving a signal.

2. The nail-mounted tactile displaying device of claim 1, further comprising a processing unit provided in the body and configured for transmitting the signal to the plurality of vibration units based on an instruction to control a vibration order, vibration intensity, or a vibration frequency of the plurality of vibration units.

3. The nail-mounted tactile displaying device of claim 2, wherein the processing unit receives the instruction via a wireless network.

4. The nail-mounted tactile displaying device of claim 2, wherein the processing unit receives the instruction via a wired network.

5. The nail-mounted tactile displaying device of claim 2, wherein the processing unit actuates at least one of the plurality of vibration units at the same time.

6. The nail-mounted tactile displaying device of claim 1, wherein the plurality of vibration units are in a number of four, located at four corners of the body, respectively, and arranged in a 2×2 matrix.

7. The nail-mounted tactile displaying device of claim 6, wherein any two of the plurality of vibration units are spaced at a distance ranging from 4 to 16 mm.

8. The nail-mounted tactile displaying device of claim 7, wherein the vibration order of the plurality of vibration units forms an order of strokes in EdgeWrite stroke recognition text entry method.

9. The nail-mounted tactile displaying device of claim 1, wherein the vibration units comprise at least one of an eccentric rotating mass actuator, a linear resonant actuator and a miniature multilayer piezo actuator.

10. The nail-mounted tactile displaying device of claim 1, wherein the plurality of vibration units are in a number of five, and arranged in a 1×5 matrix.

11. The nail-mounted tactile displaying device of claim 1, wherein the plurality of vibration units are in a number of five, and arranged in a 5×1 matrix.

12. The nail-mounted tactile displaying device of claim 1, wherein the body is a synthetic finger nail.

13. The nail-mounted tactile displaying device of claim 1, wherein the body has an appearance that approximates an appearance of a finger nail.
